(19) United States
(12) Patent Application Publication
(10) Pub. No.: US 2013/0278837 A1
(43) Pub. Date: Oct. 24, 2013

(54) Multi-Media Systems, Controllers and Methods for Controlling Display Devices

(71) Applicant: O2MICRO INC., Santa Clara, CA (US)

(72) Inventors: Sterling Shyundii Du, Shanghai (CN); Jingjing Zuo, Beijing (CN); Chengxia He, Chengdu (CN); Qi Zhu, Chengdu (CN); Zhibin Hua, Shenzhen (CN)

(73) Assignee: O2Micro Inc., Santa Clara, CA (US)

(21) Appl. No.: 13/865,567

(22) Filed: Apr. 18, 2013

(30) Foreign Application Priority Data
Apr. 23, 2012 (CN) 201210122177.X

(51) Int. Cl. G06F 3/01

(52) U.S. Cl. CPC G06F 3/013
USPC 348/734; 345/156

(57) ABSTRACT

A multi-media system includes a display device and a controller. The display device receives a video signal indicating image content and displays the image content according to the video signal. The controller captures a user's information, identifies a user's sensory state according to captured user information, and generates a control signal according to the sensory state for controlling the display device. The user information includes image information. The sensory state includes eyeball movement.

### RELATED APPLICATIONS

This application claims priority to Chinese Patent Application No. 201210122177.X, titled “Multi-media Systems, Controllers and Methods for Controlling Display Devices”, filed on Apr. 23, 2012, with the State Intellectual Property Office of the People's Republic of China, which are incorporated by reference.

### BACKGROUND

Nowadays, multi-media devices such as televisions, radios and DVD players are commonly controlled via remote-controllers and there are usually multiple remote-controllers in a family's living room. Each remote-controller has multiple buttons for realizing different control operations. For example, a remote-controller for a television has more than 20 buttons for different control operations, e.g., switching channels, adjusting the volume, and adjusting the color. Therefore, it's relatively inconvenient for the users to control all the multi-media devices by remote controllers with so many buttons.

### SUMMARY

Embodiments of the present invention provide a multi-media system. The multi-media system includes a display device and a controller. The display device receives a video signal indicating image content and displays the image content according to the video signal. The controller captures a user's information, identifies a user's sensory state according to captured user information, and generates a control signal according to the sensory state for controlling the display device. The user information includes image information. The sensory state includes eyeball movement.

Embodiments of the present invention provide a controller for controlling a display device. The controller includes a sensor and a processor. The sensor captures information related to a user and generates a monitoring signal. The information includes image information. The monitoring signal includes an image monitoring signal. The processor coupled to the sensor identifies the user sensory state according to the monitoring signal and generates a control signal according to the sensory state to control the display device. The sensory state comprises eyeball movement.

Embodiments of the present invention provide a method for controlling a display device. The method includes: monitoring a user near the display device; capturing information related to the user by a sensor; identifying a sensory state of the user according to the information; generating a control signal according to the sensory state to control the display device. The information includes image information. The sensory state includes eyeball movement.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a diagram of a multi-media system of the present invention.

FIG. 2A illustrates a front view of a controller in the multi-media system shown in FIG. 1.

FIG. 2B illustrates a back view of a controller in the multi-media system shown in FIG. 1.

FIG. 3 illustrates a block diagram of a controller in a multi-media system.

FIG. 4 illustrates a detailed block diagram of a processor in the controller shown in FIG. 3.

FIG. 5 illustrates examples of eyeball positions.

FIG. 6 illustrates examples of gesture positions.

FIG. 7 illustrates examples of sound signals.

FIG. 8 illustrates a table of data format.

FIG. 9 illustrates a flowchart of operations performed by a multi-media system.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “receiving”, “identifying”, “generating”, or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present invention provide a multi-media system, a method for controlling a display device, and a controller. The multi-media system includes a display device and a controller. The display device receives a video signal indicating image content and displays the image content according to the video signal. The controller captures a user's information, identifies a user's sensory state according to captured user information, and generates a control signal according to the sensory state for controlling the display device. The user information includes image information. The sensory state includes eyeball movement. Advantageously, the multi-media system of the present invention can control the display device by detecting user's eyeball movement, which facilitates the controlling of the display device.

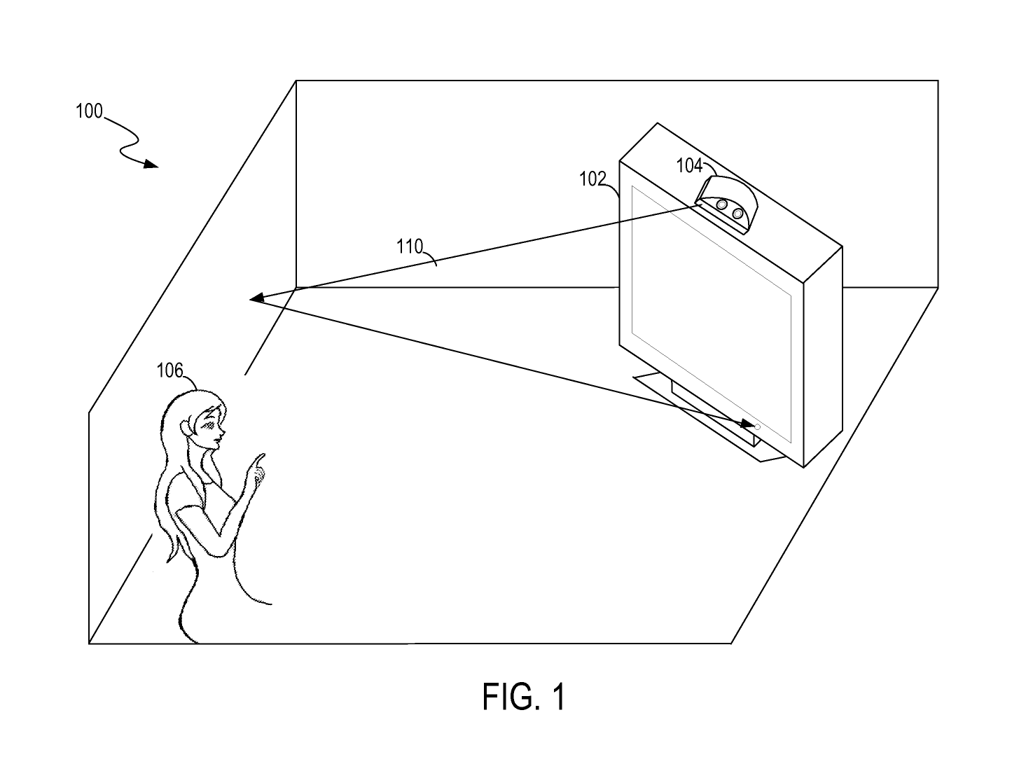

FIG. 1 illustrates a diagram of a multi-media system 100, in an embodiment of the present invention. The multi-media system 100 includes a display device 102 and a controller 104. The display device 102 is used for displaying multi-media content. For example, the display device 102 receives a video signal indicating the image content and displays a static picture or a dynamic motion according to the video signal. Moreover, the display device 102 is able to play sounds. In one embodiment, the display device 102 includes, but not limited to, a television, a computer display, a cell phone or a projector.

The controller 104 monitors the user near the display device 102, captures user's information such as images and sounds, identifies user's sensory state according to captured user information, and controls the display device 102 according to the sensory state. The user's information includes image information and sound information. The sensory state includes user's eyeball rotation, gesture, and sound characteristics. In the embodiment of FIG. 1, the display device 102 is shown as a television, and the controller 104 is placed above the television 102. A user 106 is using the television 102 in a room where the television 102 and the controller 104 are. However, it is understood that such description is for illustrative purpose only and does not intend to limit the scope of the present teaching. It is understood that any other display device, such as but not limited to, a computer display, a cell phone and a projector may be applied in the present teaching.

The sensory state includes but not limited to eyeball rotation, gesture, sound characteristics or any combination thereof. The controller 104 generates a control signal based on user's sensory state. In one embodiment, the controller 104 generates the control signal based on user 106's eyeball rotation to control the operation of the television 102. In another embodiment, the controller 104 generates the control signal based on user 106's eyeball rotation and gesture. In yet another embodiment, the controller 104 generates the control signal based on user 106's eyeball rotation and sound characteristics.

In one embodiment, the controller 104 sends out an infrared control signal 110 as the control signal. The infrared control signal 110 is provided to the television 102 and the television 102 changes its operation according to the infrared control signal 110. Alternatively, the controller 104 can provide the control signal to the television 102 by other wireless connecting means or other wired interface. Therefore, the user 106 can control the operation of the display device in a relatively simple way by sensory state, for example, simple eyeball rotation. Compared to the conventional remote-controllers, the sensory state controlling method of the present invention facilitates user's operation.

In one embodiment, the operation of television 102 includes, but not limited to, selecting a channel, adjusting the volume, and selecting a target in the television display. In one embodiment, the operation of selecting a target includes moving a cursor on the television display according to user 106's eyeball rotation, fixing the cursor on a target, and selecting the target. In one embodiment, for example, the user can select a target on the television display by rotating eyeballs, or adjust the volume by rotating eyeballs and making gestures, or select a channel by rotating eyeballs and making a voice command.

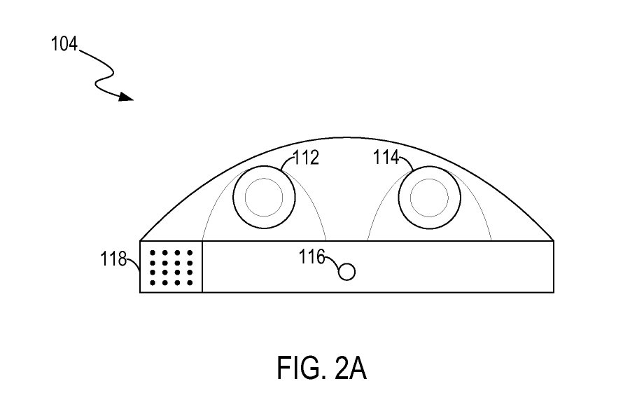

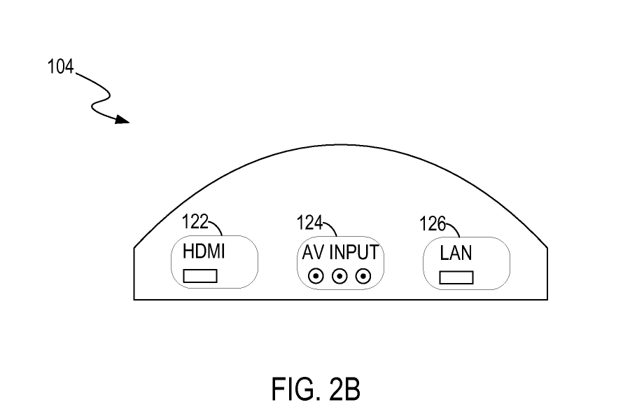

FIG. 2A and FIG. 2B illustrate a front view and a back view of the controller 104, respectively, in an embodiment according to the present invention. FIG. 2A and FIG. 2B are described in combination with FIG. 1.

As illustrated in FIG. 2A, the controller 104 includes a sensor for capturing user's image information and sound information. The sensor includes a pair of cameras 112 and 114, and a sound sensor 116. For example, the sound sensor 116 can be but not limited to a microphone. The camera 112 is a gray-scale image sensor for capturing the gray-scale images. The camera 114 is an infrared image sensor for capturing the infrared images. By using the cameras with two different operation principles, the accuracy and fidelity of the captured images are enhanced and the quality of the images is less influenced by the surroundings. For example, in an environment with relatively strong light, the gray-scale camera 112 can capture a relatively clear image; in an environment with relatively weak light, the image captured by the gray-scale camera 112 is relatively blurred, however, the infrared image captured by the infrared camera 114 serves as a backup so as to guarantee the accuracy of the captured image. The controller 104 can include additional cameras and other types of cameras and is not limited to the example shown in FIG. 2A. Furthermore, the sound sensor 116 operates for sensing the user's sound.

The controller 104 is further equipped with an infrared emitter 118 for sending out the infrared control signal 110 as the control signal. In one embodiment, the controller 104 generates a control signal according to user 106's sensory state and provides the control signal to the television 102 by the infrared control signal 110 so as to control the operation of the television 102.

As illustrated in FIG. 2B, the controller 104 is further equipped with multiple interfaces for connecting to the television 102 and the internet. The interfaces of the controller 104 include, but not limited to, a high definition multi-media interface (HDMI) 122, an audio video (AV) input interface 124 and a local area network (LAN) interface 126. The LAN interface 126 provides access to the internet by wires and receives the audio and video content from the internet. The HDMI 122 and the AV input interface 124 provide access to other electronic devices. e.g., a computer, and transfer the audio and video content from the computer to the television 102 for playing. In one embodiment, the controller 104 provides the display content, e.g., the cursor or a specific image to be displayed on the television 102, through the HDMI 122 or AV input interface 124 to the television 102. The controller 104 can control the display position or the size of the cursor on the television 102 according to changes of eyeball rotation, gesture or sound of the user 106. The controller 104 can further include other interfaces and is not limited to the example shown in FIG. 1C.

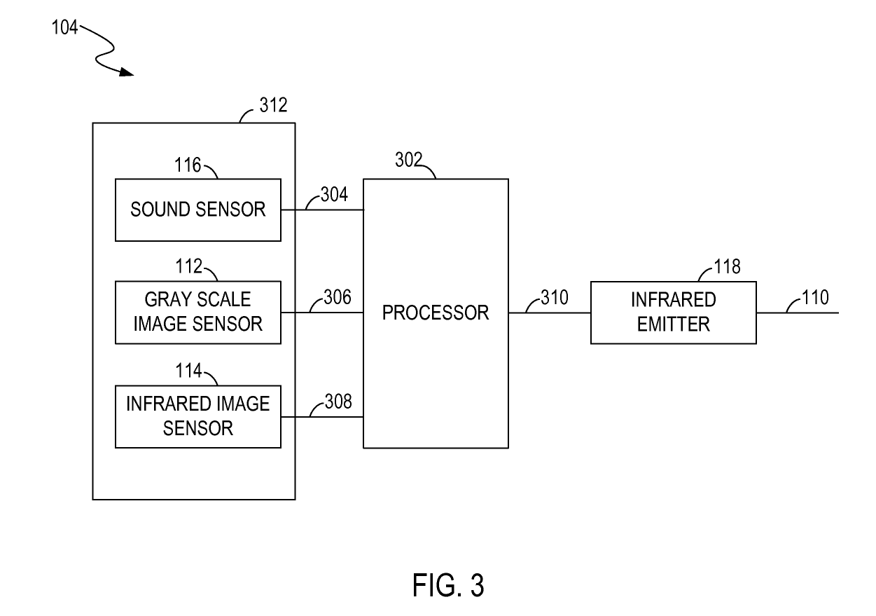

FIG. 3 illustrates a block diagram of the controller 104 shown in FIG. 1, in an embodiment according to the present invention. Elements labeled the same as in FIG. 1 and FIG. 2A have similar functions. FIG. 3 is described in relation to FIG. 1-FIG. 2A.

In one embodiment, the controller 104 includes a sensor 312, a processor 302 and the infrared emitter 118. The sensor 312 for capturing user's image information and sound information includes the sound sensor 116, the gray-scale image sensor 112 and the infrared image sensor 114. The sound sensor 116 operates for sensing user 106's sound based on captured sound information and generating a sound monitoring signal 304. The gray-scale image sensor 112 and the infrared image sensor 114 operate for sensing user 106's image based on captured image information and generating multiple image monitoring signals. Specifically, the gray-scale image sensor 112 is used for generating a first image monitoring signal 306. The infrared image sensor 114 is used for generating a second image monitoring signal 308. The processor 302 is coupled to the sensor 312, that is, the processor 302 is coupled to the sound sensor 116, the gray-scale image sensor 112 and the infrared image sensor 114, for identifying user 106's sensory state according to the monitoring signals and generating the control signal 310 to control the television 102. The infrared emitter 118 generates the infrared control signal 110 according to the control signal 310, and sends out the infrared control signal 110.

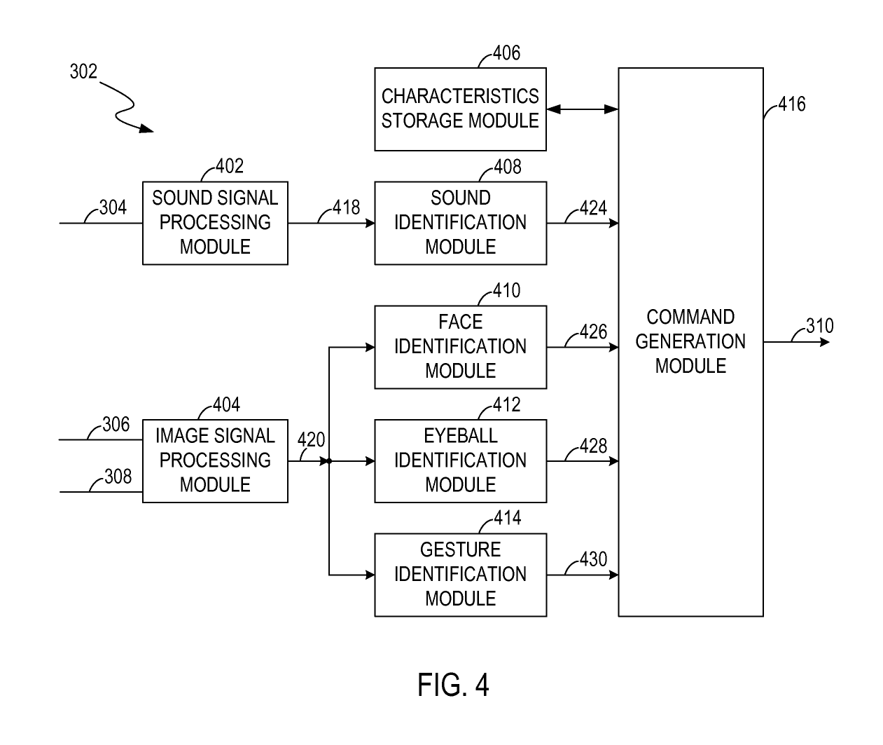

FIG. 4 illustrates a diagram of the processor 302 in the controller 104, in an embodiment according to the present invention. Elements labeled the same as in FIG. 3 have similar functions. FIG. 4 is described in relation to FIG. 3.

The processor 302 includes a sound signal processing module 402 and an image signal processing module 404. The sound signal processing module 402 receives the sound monitoring signal 304 and processes the received sound monitoring signal 304. For example, the sound signal processing module 402 can filter the sound monitoring signal 304. Thus, the sound signal processing module 402 generates a processed sound signal 418. The image signal processing module 404 receives the first image monitoring signal 306 and the second image monitoring signal 308, performs digital image processing on the received first image monitoring signal 306 and the received second image monitoring signal 308 to generate a processed image signal 420. For example, the image signal processing module 404 can filter and amplify the first image monitoring signal 306 and the second image monitoring signal 308. Thus, the image signal processing module 404 generates the processed image signal 420.

The processor 302 further includes a sound identification module 408, a face identification module 410, an eyeball identification module 412 and a gesture identification module 414 for identifying the user's sensory state. In one embodiment, the user's sensory state includes, but not limited to, the eyeball rotation, the gesture, and the sound characteristics information.

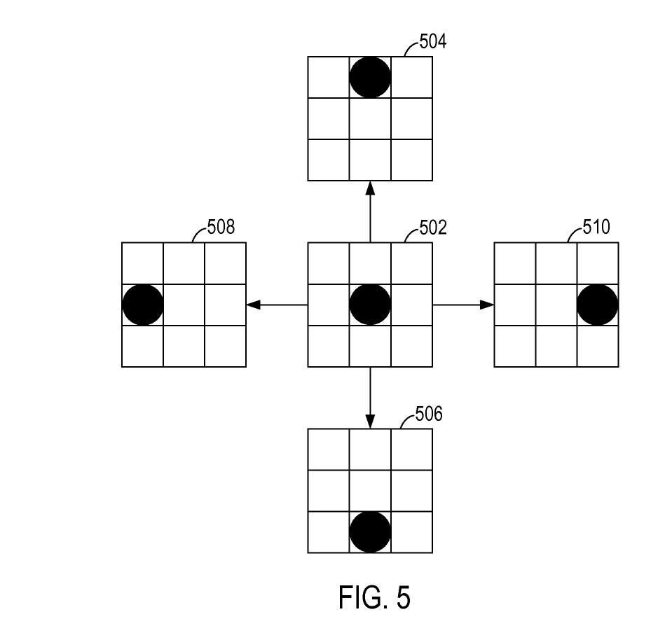

The sound identification module 408 can identify characteristics information, e.g., the frequency, the tune and the loudness, of the sound represented by the processed sound signal 418, and generate a sound identification signal 424 indicating user's identity and sound content according to the identified characteristics information. Recognizing a user's identity and sound content is done by voice recognition, which is well known to those skilled in the art and will not be described here. The face identification module 410 receives the processed image signal 420 and extracts user 106's facial characteristics information from the processed image signal 420. In one embodiment, the face identification module 410 determines whether the user 106 is an authorized user according to user 106's facial characteristics information and generates a face identification signal 426 accordingly. Recognizing whether a user is an authorized user is done by facial recognition, which is well known to those skilled in the art and will not be described here. The eyeball identification module 412 extracts the eyeball position information from the processed image signal 420, identifies characteristics information of the eyeball rotation according to the eyeball position information as will be described in FIG. 5, and accordingly generates an eyeball identification signal 428 indicating the identified characteristics information. For example, the characteristic information includes, but not limited to, the motion direction of the eyeball rotation, the motion distance of the eyeball rotation, and the focus point of the eyeball. Accordingly, the eyeball identification signal 428 indicates the motion direction of the eyeball rotation, the motion distance of the eyeball rotation, and the focus point of the eyeball. The gesture identification module 414 is able to identify different physical gestures, including dynamic and static hand gestures. The gesture identification modules 414 can extract the finger position information from the processed image signal 420, identifies motion direction and the state of the finger, e.g., dynamic or static, according to the finger position information, and accordingly generates a gesture identification signal 430 indicating the motion direction and state of the finger.

The processor 302 further includes a characteristics storage module 406 and a command generation module 416. The characteristics storage module 406 is used for storing state data for sensory state and for storing command data for multiple commands. For example, the state data for sensory states include, but not limited to, sound identification signal, face identification signal, eyeball identification signal and gesture identification signal. The command generation module 416 receives the sound identification signal 424, the face identification signal 426, the eyeball identification signal 428 and the gesture identification signal 430, and searches a corresponding command data in the characteristics storage module 406 according to any of these received identification signals, so as to generate the control signal 310 embedded with the corresponding command data to control the television 102. Generation of the control signal 310 will be described in detail in FIG. 5-FIG. 8. In one embodiment, the characteristics storage module 406 further stores characteristic sonic data for the authorized user. When the sound identification signal 424 does not match with the characteristic sonic data, the command generation module 416 generates a control signal 310 to turn off the television 102. The characteristics storage module 406 may also store facial data of authorized users. When the face identification signal 426 does not match with the facial data of a recognized user, the command generation module 416 generates a control signal 310 to turn off the television 102.

FIG. 5 illustrates examples of eyeball positions, in an embodiment according to the present invention. FIG. 5 is described in relation to FIG. 4. As illustrated in FIG. 5, the eyeball identification module 412 captures two frames of eyeball position images at time t1 and t2. By default, the position image 502 illustrating the position image is captured at time t1 when the eyeball is in a center position. The position images 504, 506, 508 and 510 illustrate some possible situations for eyeball position image at time t2. At time t2, the eyeball can move from a position in image 502 to position in image 504, 506, 508 or 510, which corresponds to eyeball rotates upward, downward, left or right, respectively. Eyeball position at time t2 remaining unchanged from the eyeball position at time t1 indicates that the user 106 is focusing on a target.

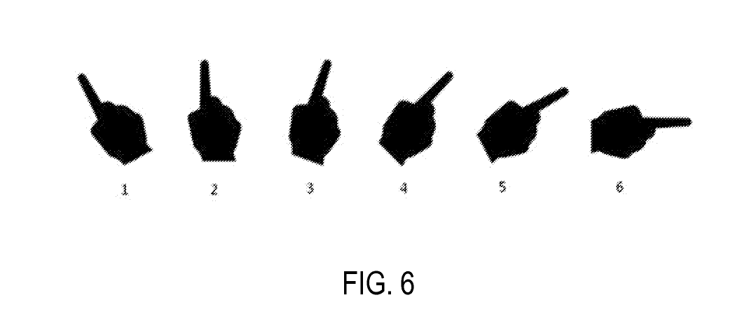

FIG. 6 illustrates examples of gesture positions, in an embodiment according to the present invention. FIG. 6 is described in relation to FIG. 4. As illustrated in FIG. 6, for example, the gesture identification module 414 captures six frames of finger images at six consecutive times, respectively. Thus, the gesture identification module 414 can identify that the finger is slipping to the right. It is understood that the example shown in FIG. 6 is for illustrative purposes only and does not intend to limit the scope of the present teaching. It is understood that the gesture identification module 414 can further identify finger's other motion direction and motion distance. However, the embodiment as shown in FIG. 6 is only for illustrative purposes, there can be any number of captured frames of finger images, depending on the requirements of particular applications.

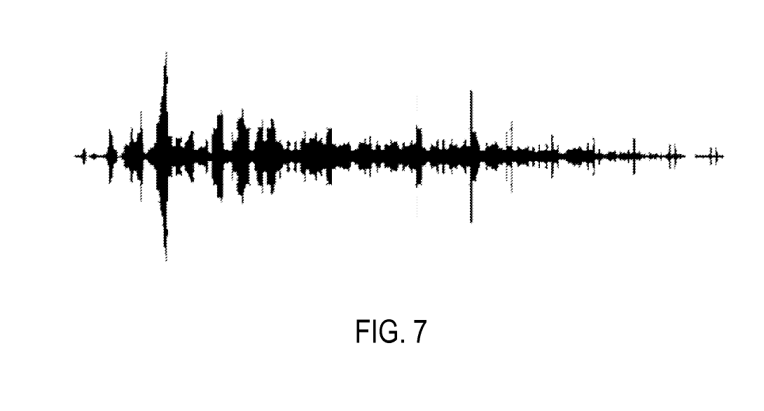

FIG. 7 illustrates examples of sound signals, in an embodiment according to the present invention. FIG. 7 is described in relation to FIG. 4. In one embodiment, the sound identification module 408 can identify the characteristics information, e.g., the frequency, the tune and the loudness, of the sound according to the processed sound signal 418. Thus, the sound identification module 408 can identify the user's identity and specific language by the sound.

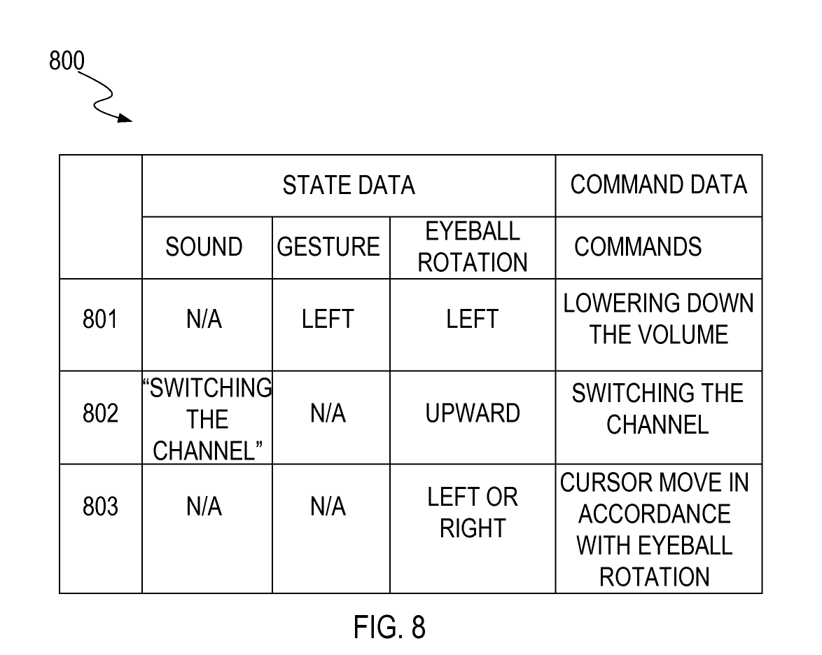

FIG. 8 illustrates a table diagram 800, in an embodiment according to the present invention. The table 800 shows the data format stored in the characteristics storage module 406. In the embodiment of FIG. 8, the table 800 includes three entries 801, 802 and 803. Each of the entries 801, 802 and 803 includes state data for user's sensory state and command data for a corresponding command. If user's sensory state matches with a sensory state in the data set, the processor 302 generates the control signal according to a corresponding command data. For example, if the identified user's sensory state indicates that the user 106 has made a “left” gesture and the eyeball is rotating “left”, the command generation module 416 determines that the identified sensory state matches the state data in the entry 801 and generates the control signal 310 to lower down the volume of the television 102 according to the command data in the entry 801. If the identified user's sensory state indicates that the user 106 has made a voice command, “switching the channel,” and the eyeball is rotating “upward”, the command generation module 416 determines that the identified sensory state matches the state data in the entry 802 and generates the control signal 310 to switch the channel of television 102 according to the command data in the entry 802. If user 106's eyeball is rotating “left” or “right” without making any gesture or sound, the command generation module 416 determines that the identified sensory state matches the state data in the entry 803 and generates the control signal 310 to control the cursor displayed in the television 102 to move in accordance with the eyeball rotation according to the command data in the entry 803. It is understood that such description is for illustrative purpose only and does not intend to limit the scope of the present teaching. It is understood that the number of the entries is not limited, and the user 106 can define the data stored in the characteristics storage module 406. In other words, the characteristics storage module 406 can further include other control commands with different formats and functions.

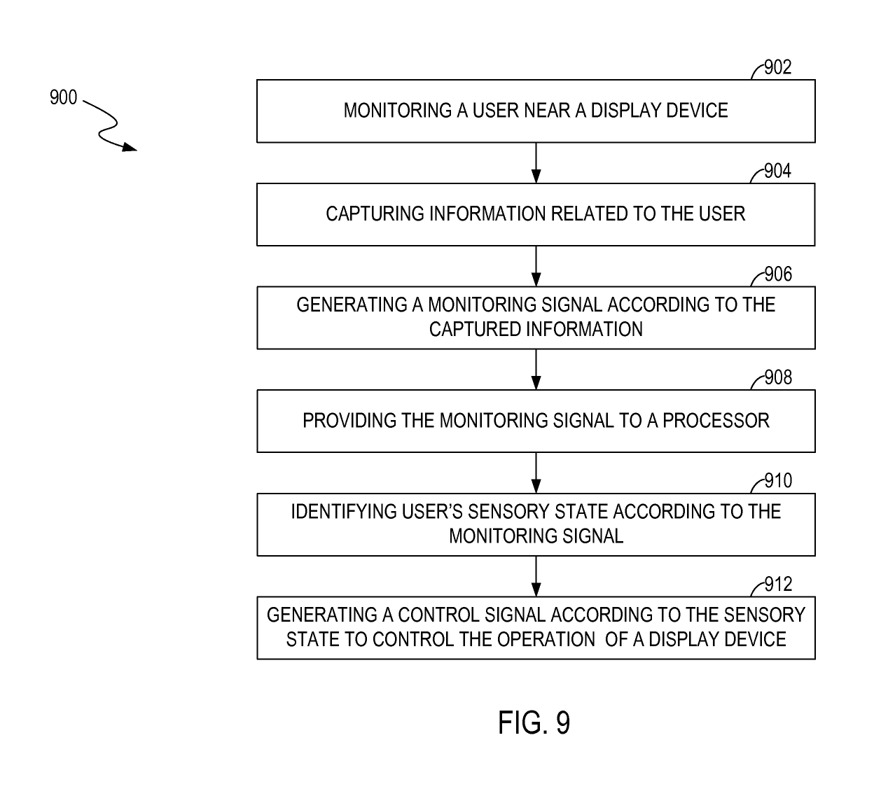

FIG. 9 illustrates a flow chart 900 of operation performed by a multi-media system 100, in an embodiment according to the present invention. FIG. 9 is described in combination with FIG. 1-FIG. 8. Although specific steps are disclosed in FIG. 9, such steps are examples. That is, the present invention is well suited to performing various other steps of variations of the steps recited in FIG. 9.

In block 902, a user near a display device is monitored by one or more sensors, e.g. a gray-scale image sensor 112, an infrared image sensor 114, and a sound sensor 116 in the controller 104. In block 904, information related to a user is captured, for example, image information and sound information.

In block 906, one or more several monitoring signals, e.g., a sound monitoring signal 304, a first image monitoring signal 306, and a second image monitoring signal 308, are generated according to the captured information. In block 908, the monitoring signal is provided to a processor, e.g., a processor 302. More specifically, the sound monitoring signal 304 is provided to a sound identification module 408 via a sound signal processing module 402 in the processor 302. The first image monitoring signal 306 and the second image monitoring signal 308 are provided to a face identification module 410, an eyeball identification module 412, and a gesture identification module 414 via an image signal processing module 404.

In block 910, user's sensory state is identified by the processor according to the monitoring signal, e.g., by the sound identification module 408, the face identification module 410, the eyeball identification module 412, and the gesture identification module 414. The sensory state includes eyeball rotation, gesture, and sound characteristics information.

In one embodiment, the characteristics information of the eyeball rotation, e.g., the motion direction of the eyeball rotation and the target of the eyeball, is identified according to the image monitoring signal, and an eyeball identification signal illustrating the characteristics information of the eyeball rotation, e.g., the eyeball identification signal 428, is generated.

In another embodiment, the characteristics information of the eyeball rotation and the characteristics information of the gesture, e.g., the motion direction and the dynamic/static state of the finger are identified according to the image monitoring signal. An eyeball identification signal indicating the eyeball rotation direction and the target, e.g., the eyeball identification signal 428, and a gesture identification signal indicating the motion direction and the dynamic/static state of the finger, e.g., the gesture identification signal 430, are generated.

In yet another embodiment, the characteristics information of the eyeball rotation and the characteristics information of the sound are identified according to the image monitoring signal and the sound monitoring signal, respectively. An eyeball identification signal indicating the eyeball rotation direction and target, e.g., the eyeball identification signal 428, and a sound identification signal indicating the user's identity and sound content, e.g., the sound identification signal 424, are generated.

In block 912, a control signal 310 is generated according to the sensory state to control the operation of the display device. In one embodiment, the control signal 310 is generated according to the eyeball identification signal generated in step 910. In another embodiment, the control signal 310 is further generated according to the eyeball identification signal and gesture identification signal generated in step 910. In yet another embodiment, the control signal 310 is further generated according to the eyeball identification signal and sound identification signal generated in step 910.

In one embodiment, the display device is a television, e.g., a television 102, and the operation at least includes channel switching, volume adjusting and target selecting in the television display. In one embodiment, the characteristics data indicating the sound characteristics of an authorized user in a characteristics storage module 406 is accessed. When the sound identification signal doesn't match with the characteristics data, a command generation module 416 generates the control signal 310 to turn off the display device, e.g., the television 102. In one embodiment, multiple data sets in the characteristics storage module 406 are accessed. Each of the data sets includes state data indicating predetermined user's sensory state and command data indicating corresponding predetermined commands. If the user's sensory state matches with the predetermined sensory state in one data set, the command generation module 416 generates the control signal 310 according to a corresponding command data. In one embodiment, the control signal 310 is provided to the display device by infrared carrier wave.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A multi-media system comprising:
a display device for receiving a video signal indicating image content and for displaying the image content according to the video signal; and
a controller for capturing a user information and for identifying a sensory state related to the user according to the captured user information, wherein the controller generates a control signal according to the sensory state for controlling the display device,
wherein the user information comprises image information and the sensory state comprises eyeball movement.

2. The multi-media system as claimed in claim 1, wherein the display device comprises a television, and the control signal controls channel switching, volume adjusting or target selecting on a display of the television.

3. The multi-media system as claimed in claim 1, wherein the controller comprises:
an image sensor for capturing the image information and for generating an image monitoring signal;
a processor coupled to the image sensor for identifying the eyeball movement according to the image monitoring signal and for generating the control signal.

4. The multi-media system as claimed in claim 3, wherein the processor comprises:
an eyeball identification module for identifying characteristics information of eyeball movement according to the image monitoring signal, and for generating an eyeball identification signal indicating the characteristics information of eyeball movement; and
a command generation module for generating the control signal according to the eyeball identification signal to control the display device.

5. The multi-media system as claimed in claim 4, wherein the processor further comprises:
a characteristics storage module for storing state data related to eyeball identification and a plurality of commands,
wherein if the eyeball identification signal matches with the state data, the command generation module generates the control signal according to a corresponding command.

6. The multi-media system as claimed in claim 3, wherein the image sensor comprises a gray-scale image sensor and an infrared image sensor.

7. The multi-media system as claimed in claim 1, wherein the sensory state further comprises gesture, and wherein the controller further comprises:
an image sensor for capturing the image information and for generating an image monitoring signal; and
a processor coupled to the image sensor for identifying the eyeball movement and gesture according to the image monitoring signal, and for generating the control signal.

8. The multi-media system as claimed in claim 7, wherein the processor further comprises:
an eyeball identification module for identifying characteristics information of eyeball movement according to the image monitoring signal, and for generating an eyeball identification signal indicating the characteristics information of eyeball movement;
a gesture identification module for identifying motion direction of a finger according to the image monitoring signal, and for generating a gesture identification signal indicating the motion direction; and
a command generation module for generating the control signal according to the eyeball identification signal and the gesture identification signal to control the display device.

9. The multi-media system as claimed in claim 8, wherein the processor further comprises:
a characteristics storage module for storing state data related to eyeball identification and gesture identification, and for storing a plurality of commands,
wherein if the eyeball identification signal and the gesture identification signal match with the state data, the command generation module generates the control signal according to a corresponding command.

10. The multi-media system as claimed in claim 1, wherein the information further comprises sound information, wherein the sensory state further comprises sound characteristics information, and wherein the controller further comprises:
an image sensor for capturing the image information and for generating an image monitoring signal;
a sound sensor for capturing the sound information and for generating an sound monitoring signal; and
a processor coupled to the image sensor and the sound sensor, and for identifying eyeball movement and sound characteristics information according to the image monitoring signal and the sound monitoring signal, respectively, and for generating the control signal.

11. The multi-media system as claimed in claim 10, wherein the controller further comprises:
an eyeball identification module for identifying characteristics information of eyeball movement according to the image monitoring signal and for generating an eyeball identification signal indicating the characteristics information of eyeball movement;
a sound identification module for identifying user identity and sound content according to the sound monitoring signal and for generating a sound identification signal indicating the user identity and the sound content; and
a command generation module for generating the control signal according to the eyeball identification signal and the sound identification signal to control the display device.

12. The multi-media system as claimed in claim 11, wherein the controller further comprises:
a characteristics storage module for storing state data related to eyeball identification and sound identification, and for storing a plurality of commands, wherein said characteristics storage module further stores characteristics data related to a sound characteristics of an authorized user,
wherein if the eyeball identification signal and the sound identification signal match with the state data, the command generation module generates the control signal according to a corresponding command, and wherein if the sound identification signal does not match with the characteristics data, the command generation module turns off the display device.

13. A method for controlling a display device, comprising:
monitoring a user near the display device;
capturing information related to the user by a sensor, wherein the information comprises image information;
identifying a sensory state of the user according to the information, wherein the sensory state comprises eyeball movement; and
generating a control signal according to the sensory state to control the display device.

14. The method as claimed in claim 13, wherein the method further comprises:
capturing the image information by a gray-scale image sensor and an infrared image sensor to generate an image monitoring signal.

15. The method as claimed in claim 13, wherein the method further comprises:
identifying characteristics information of eyeball movement according to the image information; and
generating an eyeball identification signal indicating the characteristics information of eyeball movement, wherein the control signal is generated according to the eyeball identification signal.

16. The method as claimed in claim 13, wherein the sensory state further comprises gesture, and wherein the method further comprises:
identifying characteristics information of eyeball movement and motion direction of a finger according to the image information; and
generating an eyeball identification signal indicating the characteristics information of eyeball movement and a gesture identification signal indicating the motion direction of the finger, wherein the control signal is generated according to the eyeball identification signal and the gesture identification signal.

17. The method as claimed in claim 13, wherein the information further comprises sound information, wherein the sensory state further comprises sound characteristics information, and wherein the method further comprises:
identifying characteristics information of eyeball movement according to the image information and user identity and sound content according to the sound information, respectively; and
generating an eyeball identification signal indicating the characteristics information of eyeball movement and a sound identification signal indicating the user identity and the sound content, wherein the control signal is generated according to the eyeball identification signal and the sound identification signal.

18. A controller for controlling a display device, wherein the controller comprises:
a sensor for capturing information related to a user and for generating a monitoring signal, wherein the information comprises image information, and wherein the monitoring signal comprises an image monitoring signal; and
a processor coupled to the sensor for identifying the user sensory state according to the monitoring signal and for generating a control signal according to the sensory state to control the display device, wherein the sensory state comprises eyeball movement.

19. The controller as claimed in claim 18, wherein the processor comprises:
an eyeball identification module for identifying characteristics information of eyeball movement according to the image monitoring signal and for generating an eyeball identification signal indicating the characteristics information of eyeball movement; and
a command generation module for generating the control signal according to the eyeball identification signal to control the display device.

20. The controller as claimed in claim 19, wherein the controller further comprises:
a characteristics storage module for storing state data related to eyeball identification and for storing a plurality of commands,
wherein if the eyeball identification signal matches with the state data, the command generation module generates the control signal according to a corresponding command.

21. The controller as claimed in claim 18, wherein the sensory state further comprises gesture, and wherein the processor comprises:
an eyeball identification module for identifying characteristics information of eyeball movement according to the image monitoring signal and for generating an eyeball identification signal indicating the characteristics information of eyeball movement;
a gesture identification module for identifying motion direction of a finger according to the image monitoring signal and for generating a gesture identification signal indicating the motion direction of the finger; and
a command generation module for generating the control signal according to the eyeball identification signal and the gesture identification signal to control the display device.

22. The controller as claimed in claim 21, wherein said processor further comprises:
a characteristics storage module for storing state data related to eyeball identification and gesture identification, and for storing a plurality of commands,
wherein if the eyeball identification signal and the gesture identification signal match with the state data, the command generation module generates the control signal according to a corresponding command.

23. The controller as claimed in claim 18, wherein the information further comprises sound information, wherein the monitoring signal further comprises a sound monitoring signal, wherein the sensory state further comprises sound characteristics information, and wherein the processor comprises:
an eyeball identification module for identifying characteristics information of eyeball movement according to the image monitoring signal and for generate an eyeball identification signal indicating the characteristics information of eyeball movement;
a sound identification module for identifying user identity and sound content according to the sound monitoring signal and for generating a sound identification signal indicating the user identity and the sound content; and
a command generation module for generating the control signal according to the eyeball identification signal and the sound identification signal to control the display device.

24. The controller as claimed in claim 23, wherein said processor further comprises:
a characteristics storage module for storing state data related to eyeball identification and sound identification and for storing a plurality of commands, wherein the characteristics storage module further stores characteristics data indicating a sound characteristics of an authorized user,
wherein if the eyeball identification signal and the sound identification signal match with the state data, the command generation module generates the control signal according to a corresponding command, and the command generation module generates the control signal to turn off the display device when the sound identification signal does not match with the characteristics data.
